(19) United States
(12) Patent Application Publication
(10) Pub. No.: US 2017/0366390 A1
(43) Pub. Date: Dec. 21, 2017

(54) INFORMATION PROCESSING APPARATUS AND INFORMATION PROCESSING SYSTEM

(71) Applicant: Fujitsu Limited, Kawasaki-shi (JP)

(72) Inventor: Masanori TAKAOKA, Kawasaki (JP)

(73) Assignee: Fujitsu Limited, Kawasaki-shi (JP)

(21) Appl. No.: 15/695,545

(22) Filed: Sep. 5, 2017

Related U.S. Application Data
(63) Continuation of application No. PCT/JP2015/057040, filed on Mar. 10, 2015.

(51) Int. Cl. H04L 29/14; H04L 12/931; H04L 29/04

(52) U.S. Cl. CPC H04L 29/14; H04L 49/35; H04L 29/04

(57) ABSTRACT

An information processing apparatus includes, in an aspect, a communication port, a reading unit, a determination unit, a collecting unit, and a sending unit. When a communication cable is connected to the communication port, the reading unit reads a failure condition table and a collection item table from a storage unit provided in a communication cable. The determination unit determines whether the state of communication via the communication cable connected to the communication port satisfies the condition in the failure condition table. When the determination unit determines that the state of the communication via the communication cable connected to the communication port satisfies the condition, the collecting unit collects the information corresponding to the item in the collection item table. The sending unit sends the information collected by the collecting unit to a predetermined device.

### CROSS-REFERENCE TO RELATED APPLICATION

This application is a continuation of International Application No. PCT/JP2015/057040, filed on Mar. 10, 2015, the entire contents of which are incorporated herein by reference.

### FIELD

The embodiment discussed herein is related to an information processing apparatus and an information processing system.

### BACKGROUND

In an evaluation of switch devices in the shipping stage, a test is often performed by variously changing the connections between a plurality of switch devices or by variously changing the types of communication cables that are used for the connections between the switches. Each of the switch devices monitors communication data that is sent and received via a communication port to which the communication cable is connected and holds information, such as a statistical value of the communication data, a value of an error counter, a communication state with another adjacent switch device, and the like.

If a failure occurs in a communication system in which the plurality of switch devices are connected, a worker who evaluates the switch devices accesses the respective switch devices by using a management terminal and collects the information held by the switch devices. Then, the worker performs the work of specifying a portion in which a failure occurs or finding out the cause of the failure by using the information collected from each of the switch devices.

Furthermore, in some cases, each of the switch devices is provided with a function of detecting the occurrence of a failure when the error rate of the communication data exceeds a predetermined threshold. The information, such as a threshold of the error rate used to detect the occurrence of a failure, may sometimes vary depending on the type of the communication cable connected to the communication port. Consequently, if the type of the communication cables used to connect the switch devices is changed, the worker accesses the switch devices by using the management terminal and changes the information, such as the threshold of the error rate, or the like, in accordance with the type of the communication cables connected to the switch devices. Prior art examples are disclosed in Japanese Laid-open Patent Publication No. 2007-74344, Japanese Laid-open Patent Publication No. 2010-154557, and Japanese Laid-open Patent Publication No. 06-175887.

However, if the number of switch devices targeted for the evaluation is increased, the number of switch devices to which the worker accesses by using the management terminal is increased and thus it takes a long time for the work of collecting the information that is used to specify the portion in which the failure occurs or the like. Furthermore, if the number of switch devices targeted for evaluation is increased, the number of switch devices targeted for the change in the setting of the threshold of the error rate or the like is increased in accordance with the change in the type of the communication cables that connect the switch devices. Consequently, there is a problem in that it takes a long time to evaluate the switch devices.

### SUMMARY

According to an aspect of an embodiment, an information processing apparatus includes a communication port, a reading unit, a determination unit, a collecting unit, and a sending unit. The communication port is connected to a communication cable. The reading unit reads, from a first storage unit provided in the communication cable when the communication cable is connected to the communication port, a failure condition table including a condition used for determination of failure occurrence and a collection item table including an item of information collected when the condition is satisfied. The determination unit determines whether a state of communication via the communication cable connected to the communication port satisfies the condition included in the failure condition table read by the reading unit. The collecting unit collects, when the determination unit determines that the state of the communication via the communication cable connected to the communication port satisfies the condition, the information corresponding to the item included in the collection item table read by the reading unit. The sending unit sends the information collected by the collecting unit to a predetermined device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an information processing system;

FIG. 2 is a block diagram illustrating an example of a communication cable;

FIG. 3 is a schematic diagram illustrating an example of a failure condition table stored by a storage unit in the communication cable;

FIG. 4 is a diagram illustrating an example of a collection item table stored by the storage unit in the communication cable;

FIG. 5 is a block diagram illustrating an example of a switch device;

FIG. 6 is a block diagram illustrating an example of the switch device;

FIG. 7 is a diagram illustrating an example of a per-port failure condition table stored by a storage unit in the switch device;

FIG. 8 is a diagram illustrating an example of a per-port collection item table stored by the storage unit in the switch device;

FIG. 9 is a diagram illustrating an example of a collection information table;

FIG. 10 is a flowchart illustrating an example of an operation performed by the switch device;

FIG. 11 is a flowchart illustrating an example of an operation performed by the switch device; and

FIG. 12 is a diagram illustrating an example of a communication device that implements a function of the switch device.

### DESCRIPTION OF EMBODIMENTS

Preferred embodiments of the present invention will be explained with reference to accompanying drawings. Furthermore, the present application is not limited to the embodiment described below. Furthermore, the embodiments can be used in any appropriate combination as long as the processes do not conflict with each other.

Information Processing System 10

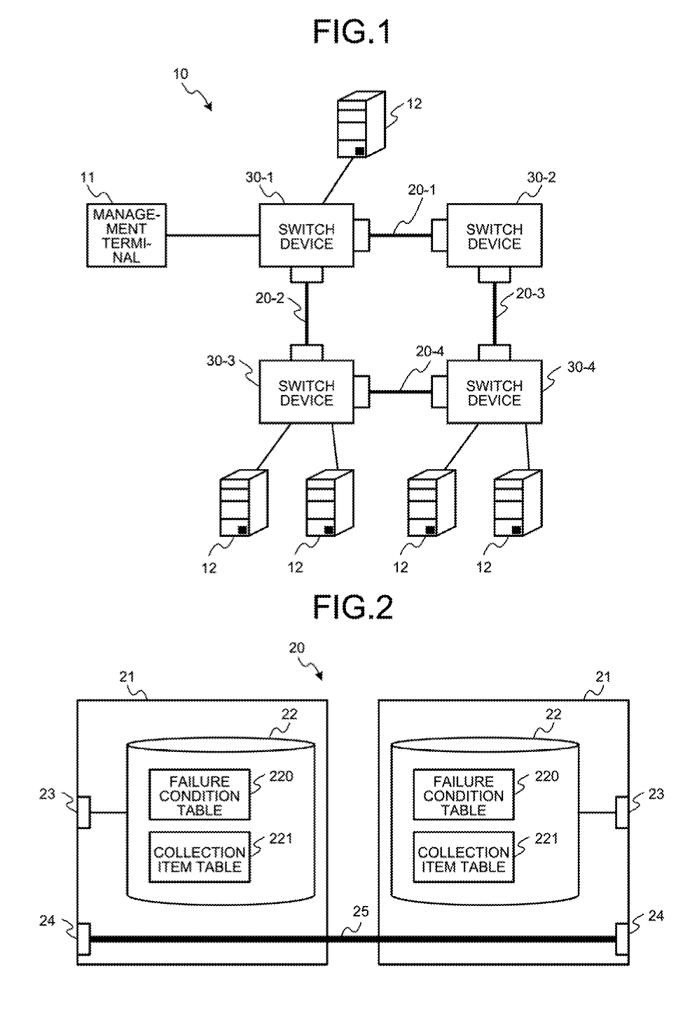

FIG. 1 is a diagram illustrating an information processing system 10. The information processing system 10 includes a plurality of switch devices 30 (30-1 to 30-4) and a plurality of communication cables 20 (20-1 to 20-4) that connects the switch devices 30. Furthermore, in a description below, if there is no need to distinguish between the communication cables 20-1 to 20-4, the communication cables 20-1 to 20-4 are generically referred to as the communication cable 20 and, if there is no need to distinguish between the switch devices 30-1 to 30-4, the switch devices 30-1 to 30-4 are generically referred to as the switch device 30.

Each of the switch devices 30 is connected to the other switch devices 30 via the communication cable 20. The switch device 30 is an example of an information processing apparatus. In the embodiment, each of the switch devices 30 has the function of fabric. Furthermore, the plurality of the switch devices 30 connected with each other via the communication cables 20 is virtually operated as a single switch and relays the communication data sent from a server 12 to the server 12 that is the destination. Furthermore, the information processing system 10 exemplified in FIG. 1 includes the four switch devices 30 that are connected with each other by the communication cables 20; however, the information processing system 10 may also include the four or more switch devices 30 that are connected with each other by the communication cables 20.

If the fabric is constituted by the plurality of the switch devices 30, one of the switch devices 30 constituting the fabric manages and monitors the other switch devices 30. Furthermore, the ID number is allocated to each of the switch devices 30 constituting the fabric and each of the switch devices 30 is managed by the ID. In a description below, from among the plurality of the switch devices 30 constituting the fabric, the switch device 30 that manages and monitors the other switch devices 30 is referred to as a management switch, whereas the other switch devices 30 managed by the management switch is referred to as an unmanaged switch. In the information processing system 10 exemplified in FIG. 1, for example, the switch device 30-1 is a management switch and, for example, the switch devices 30-2 to 30-4 are unmanaged switches.

Here, in an evaluation of the function of the fabric in the production shipping stage of the switch devices 30, a test is performed by variously changing connections of the plurality of the switch devices 30 or by variously changing the types of communication cables that connect between the switch devices 30. There are various types of cables that connect between the switch devices 30 depending on the materials or the constitution. If the type of the communication cables differs, the characteristic of the transmission speed, the error rate, or the like differs.

Each of the switch devices 30 monitors statistical information, such as the error rate of the communication data that is sent and received via the communication cables. Then, for example, if the error rate of the communication data that is sent and received via the communication cables exceeds the set threshold, the switch device 30 detects a failure of the communication that is performed via the subject communication cable and notifies a predetermined device (for example, the management switch) of the failure occurrence. Because the characteristic of the transmission speed, the error rate, or the like varies depending on the type of the communication cables that connect the switch devices 30, the threshold that is used to detect the occurrence of a failure is set in the switch devices 30 in accordance with the type of the communication cables to be connected.

In the fabric test performed by changing the type of the communication cables that connect the switch devices 30, every time the type of the communication cables connected to the switch devices 30 is changed, a threshold or the like that is in accordance with the type of the connected communication cables is set in the switch devices 30. If it is assumed that, every time the type of the communication cables connected to the switch devices 30 is changed, a worker who performs the fabric test sets the threshold or the like that is in accordance with the type of the connected communication cables, the burden placed on the worker is great.

In contrast, in the information processing system 10 according to the embodiment, in the storage unit provided in each of the communication cables 20, a failure condition table including the conditions used for determination of the failure occurrence associated with the type of the communication cables 20 is stored. Then, if the communication cable 20 is connected, the switch device 30 reads the failure condition table from the storage unit in the communication cable 20 and stores the read data in the storage unit in the switch device 30.

The switch device 30 monitors statistical information on, for example, the error rate of the communication data that is sent and received via the communication cable 20. Then, if the statistical information on the communication data sent and received via the communication cable 20 satisfies the condition stored in the failure condition table, the switch device 30 detects the occurrence of a failure and notifies a predetermined device of the information on the detected failure. Consequently, the information processing system 10 can eliminate the worker's trouble of setting the condition of the threshold or the like associated with the type of the communication cable 20 in the corresponding switch device 30 every time the type of the communication cable 20 connected to the switch device 30 is changed.

Furthermore, in the information processing system 10 according to the embodiment, in the storage unit provided in each of the communication cables 20, a collection item table including the item of information that is collected if a failure occurs. Then, each of the switch devices 30 reads, if the communication cable 20 is connected, the collection item table from the storage unit in the communication cable 20 and stores the read data in the storage unit in the switch device 30.

Then, if the switch device 30 detects the communication failure based on the statistical information on the error rate or the like of the communication data that is sent and received via the communication cable 20, the switch device 30 collects the information associated with the item included in the collection item table. Then, the switch device 30 notifies the predetermined device (for example, a management switch) of the collected information together with the information on the detected failure. Consequently, if a communication failure occurs, the information processing system 10 can reduce the burden placed on the worker for collecting the information that is used to find out the portion in which a failure occurs or find out the cause of the failure.

Communication Cable 20

FIG. 2 is a block diagram illustrating an example of the communication cable 20. The communication cable 20 includes a cable main body 25 and connectors 21 that are provided at both ends of the cable main body 25. The cable main body 25 is, for example, a Twinax (2-core coaxial stranded wire) cable. Each of the connectors 21 is provided with storage units 22. The storage unit 22 is implemented by, for example, a nonvolatile memory, such as an electrically erasable programmable read-only memory (EEPROM), or the like.

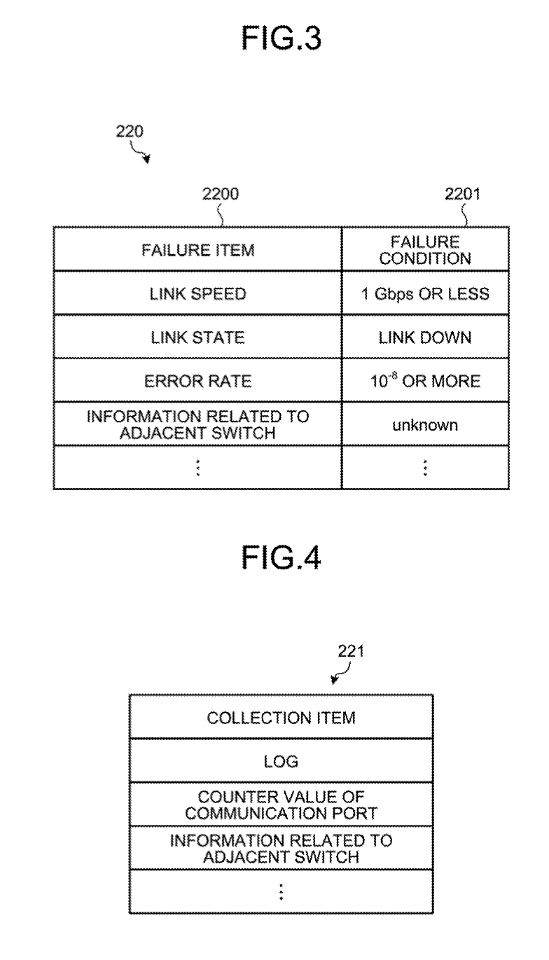

The storage unit 22 stores therein a failure condition table 220 and a collection item table 221. FIG. 3 is a schematic diagram illustrating an example of the failure condition table 220 stored by the storage unit 22 in the communication cable 20. The failure condition table 220 stores therein a failure condition 2201 in association with a failure item 2200. The failure item 2200 indicates the item of the information that is used for the determination of the failure occurrence. If it is determined that a failure occurs, the failure condition 2201 indicates the condition satisfied by the information associated with the failure item 2200.

Here, in FIG. 3, the “link speed” is the item indicating a transmission speed of communication data sent and received via the communication cable 20. Furthermore, in FIG. 3, the “link state” is the item indicating whether communication with the other communication cable 20 (hereinafter, referred to as an adjacent switch) connected via the communication cable 20 is in the available state. Furthermore, in FIG. 3, the “error rate” is the item indicating the rate of error communication data out of the communication data received via the communication cable 20.

Furthermore, in FIG. 3, the “information related to an adjacent switch” is the information related to the adjacent switch connected via the communication cable 20 that stores therein the failure condition table 220 illustrated in FIG. 3. The information related to the adjacent switch includes, for example, the MAC address or the switch ID of the adjacent switch. The switch device 30 acquires these pieces of information from the adjacent switch via the communication cable 20.

The “unknown” described in the field of the failure condition 2201 indicates the state of a failure to acquire, from the adjacent switch, information on at least one item out of the predetermined items as the information related to the adjacent switch.

Furthermore, if the type of the communication cables 20 differs, the characteristic of the maximum transmission speed, the error rate, or the like differs. Furthermore, for example, each of the storage units 22 in the communication cable 20 with the maximum transmission speed of 10 Gbps stores therein, as the failure condition for determining the failure occurrence, the failure condition table 220 including the failure condition, such as the link speed being equal to or less than 1 Gbps, the error rate being equal to or greater than 10⁻⁸, or the like. Furthermore, each of the storage units 22 in the communication cable 20 with the maximum transmission speed of 40 Gbps stores therein, as the failure condition for determining the failure occurrence, the failure condition table 220 including the failure condition, such as the link speed being equal to or less than 10 Gbps, the error rate being equal to or greater than 10⁻⁷, or the like. Furthermore, each of the storage units 22 in the communication cable 20 with the maximum transmission speed of 56 Gbps stores therein, as the failure condition for determining the failure occurrence, the failure condition table 220 including the failure condition, such as the link speed being equal to or less than 40 Gbps, the error rate being equal to or greater than 10⁻⁶, or the like. In this way, each of the storage units 22 in the communication cable 20 stores therein the failure condition table 220 including the failure condition associated with the type of the corresponding communication cable 20.

FIG. 4 is a diagram illustrating an example of the collection item table 221 stored by the storage unit 22 in the communication cable 20. The collection item table 221 stores therein the items of information collected if one of the failure conditions included in the failure condition table 220 is satisfied.

In the collection item table 221 exemplified in FIG. 4, the “log” is the information in which the operation status of the switch device 30 is recorded and that includes the record of an event that has occurred in the switch device 30. Furthermore, the “counter value of the communication port” exemplified in FIG. 4 is the counter value of the communication port of the switch device 30 to which the communication cable 20 that stores therein the collection item table 221 exemplified in FIG. 4 is connected. It is assumed that an example of the counter value of the communication port includes, for example, the number of transmission packets, the number of reception packets, the number of error packets, or the like. Furthermore, the “information related to an adjacent switch” exemplified in FIG. 4 indicates the information that can be acquired, from the adjacent switch, from among the items predetermined as the information related to the adjacent switch.

A description will be continued by referring back to FIG. 2. Each of the connectors 21 is connected to the communication port of the switch device 30. The information stored in the storage unit 22 is read by the switch device 30 via a serial interface terminal 23. The communication data sent and received between the switch devices 30 connected by the communication cable 20 is propagated from the switch devices 30 to the cable main body 25 via communication interface terminals 24 and is transmitted by the cable main body 25.

Switch Device 30

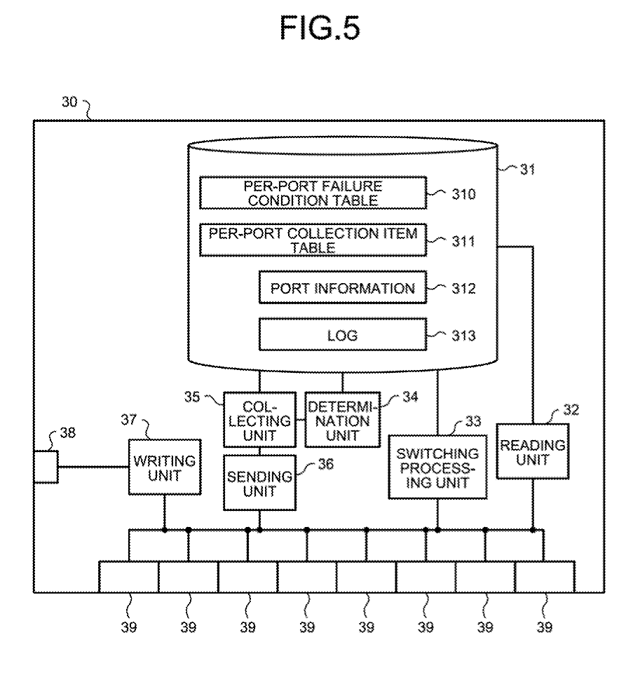

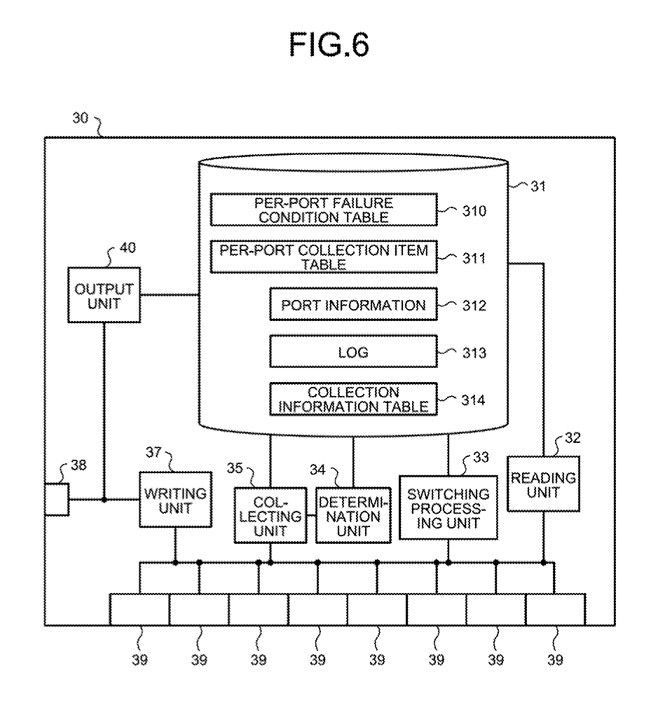

FIGS. 5 and 6 are block diagrams each illustrating an example of the switch device 30. FIG. 5 illustrates the switch device 30 operating as an unmanaged switch, whereas FIG. 6 illustrates the switch device 30 operating as a management switch. Each of the switch devices 30 is operated as the unmanaged switch or the management switch.

The switch device 30 operating as the unmanaged switch includes, for example, as illustrated in FIG. 5, a storage unit 31, a reading unit 32, a switching processing unit 33, a determination unit 34, a collecting unit 35, a sending unit 36, a writing unit 37, a maintenance port 38, and a plurality of communication ports 39.

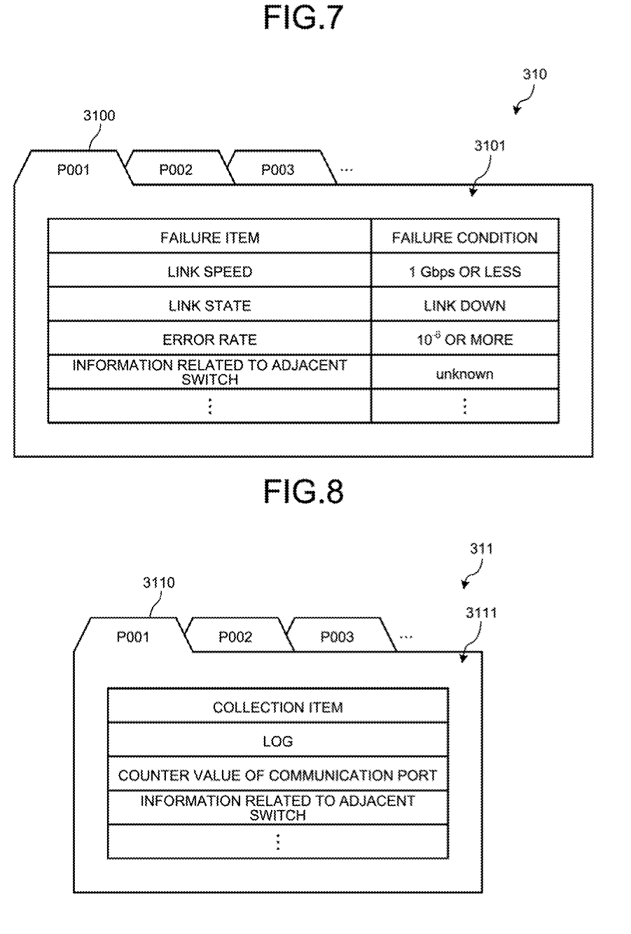

The storage unit 31 stores therein a per-port failure condition table 310, a per-port collection item table 311, port information 312, and a log 313. FIG. 7 is a diagram illustrating an example of the per-port failure condition table 310 stored by the storage unit 31 in the switch device 30. The per-port failure condition table 310 stores therein, for example, as illustrated in FIG. 7, a failure condition table 3101 for each of port IDs 3100 that identify each of the communication ports 39. Each of the failure condition tables 3101 stores therein the same information as that stored in the failure condition table 220 described with reference to, for example, FIG. 3.

FIG. 8 is a diagram illustrating an example of the per-port collection item table 311 stored by the storage unit 31 in the switch device 30. The per-port collection item table 311 stores therein, for example, as illustrated in FIG. 8, a collection item table 3111 for each of port IDs 3110 that identify each of the communication ports 39. Each of the collection item tables 3111 stores therein the same information as that stored in the collection item table 221 described with reference to, for example, FIG. 4. The information associated with the collection item stored in each of the collection item tables 3111 is stored in the port information 312, the log 313, or the like stored in the storage unit 31.

The port information 312 stores therein, for each of the communication ports 39, the statistical information on the communication data sent and received via the communication port 39, the information related to the adjacent switch connected via the communication cable 20, and the like. In the log 313, the information, such as the operation status of the switch device 30 or the like is recorded.

The reading unit 32 monitors whether the communication cable 20 is connected to the communication port 39. If the communication cable 20 is connected to the communication port 39, the reading unit 32 specifies, in the per-port failure condition table 310 in the storage unit 31, the failure condition table 3101 associated with the port ID of the communication port 39 to which the communication cable 20 is connected. Then, the reading unit 32 deletes the data in the specified failure condition table 3101. Similarly, if the communication cable 20 is connected to the communication port 39, the reading unit 32 specifies, in the per-port collection item table 311 in the storage unit 31, the collection item table 3111 associated with the port ID of the communication port 39 to which the communication cable 20 is connected. Then, the reading unit 32 deletes the data in the specified collection item table 3111.

Then, the reading unit 32 reads, from the storage unit 22 in the communication cable 20 via the communication port 39, the data in the failure condition table 220 and the data in the collection item table 221. Then, the reading unit 32 stores, in the failure condition table 3101 specified in the per-port failure condition table 310, the data in the failure condition table 220 read from the storage unit 22 stored in the communication cable 20. Furthermore, the reading unit 32 stores, in the collection item table 3111 specified in the per-port collection item table 311, the data in the collection item table 221 read from the storage unit 22 in the communication cable 20.

The switching processing unit 33 performs a process of relaying, in accordance with the information, such as the destination of the communication data, via the communication cable 20 connected to the other communication port 39, the communication data received from the other switch device 30 via the communication cable 20 connected to the communication port 39. In the embodiment, the switching processing unit 33 relays, based on the function of the fabric, the communication data in liaison with the other switch device 30. Furthermore, the switching processing unit 33 records the operation status of the event or the like that has occurred in accordance with the process of relaying the communication data or the like in the log 313 in the storage unit 31.

The determination unit 34 refers, at each timing, regarding each of the communication ports 39 to which the communication cable 20 is connected, the failure condition tables 3101 in the per-port failure condition table 310 and the port information 312. Then, the determination unit 34 determines whether one of the failure conditions included in the failure condition table 3101 is satisfied. If the determination unit 34 determines that one of the failure conditions included in the failure condition table 3101 is satisfied, the determination unit 34 notifies the collecting unit 35 of the port ID that is used to identify the communication port 39 in which the failure condition is satisfied. In this case, the determination unit 34 may also notify the collecting unit 35 of the failure item associated with the failure condition.

If the collecting unit 35 is received, from the determination unit 34, the port ID of the communication port 39 as a notification, the collecting unit 35 specifies, in the per-port collection item table 311, the collection item table 3111 associated with the notified port ID. Then, the collecting unit 35 collects, from the port information 312 or the log 313, the information associated with each of the collection items stored in the specified collection item table 3111. Then, the collecting unit 35 sends, to the sending unit 36, the information collected for each collection item together with the port ID of the communication port 39 in which the failure condition is satisfied.

If the sending unit 36 receives, from the collecting unit 35, both the information collected for each collection item and the port ID of the communication port 39 in which the failure condition is satisfied, the sending unit 36 sends, to the predetermined device, the pieces of the received information together with the switch ID that is used to identify the own device. The predetermined device is, for example, a management switch. Furthermore, the sending unit 36 may also send, together with the switch ID that identifies the own device from the communication port 39 that is other than the communication port 39 in which the failure condition is satisfied, both the information collected for each of the collection items and the port ID of the communication port 39 in which the failure condition is satisfied. Consequently, the sending unit 36 can more certainly deliver, to the predetermined device, both the information collected for each of the collection items and the port ID of the communication port 39 in which the failure condition is satisfied.

If the writing unit 37 receives the signal indicating the start of writing from a management terminal 11 via the maintenance port 38, the writing unit 37 determines whether the communication cable 20 is connected to one of the communication ports 39. If the communication cable 20 is connected to one of the communication ports 39, the writing unit 37 accesses the storage unit 22 in the communication cable 20 and deletes the failure condition table 220 and the collection item table 221 in the storage unit 22.

Then, when receiving the data on the failure condition table 220 and the collection item table 221 from the management terminal 11 via the maintenance port 38, the writing unit 37 stores the data in the failure condition table 220 and the collection item table 221 in the storage unit 22 in the communication cable 20.

The switch device 30 operating as the management switch includes, for example, as illustrated in FIG. 6, the storage unit 31, the reading unit 32, the switching processing unit 33, the determination unit 34, the collecting unit 35, the writing unit 37, the maintenance port 38, a plurality of the communication ports 39, and an output unit 40. Furthermore, the components illustrated in FIG. 6 having the same reference numerals as those illustrated in FIG. 5 have the same configuration or the similar functions as those illustrated in FIG. 5 except for the following points described below; therefore, descriptions thereof will be omitted.

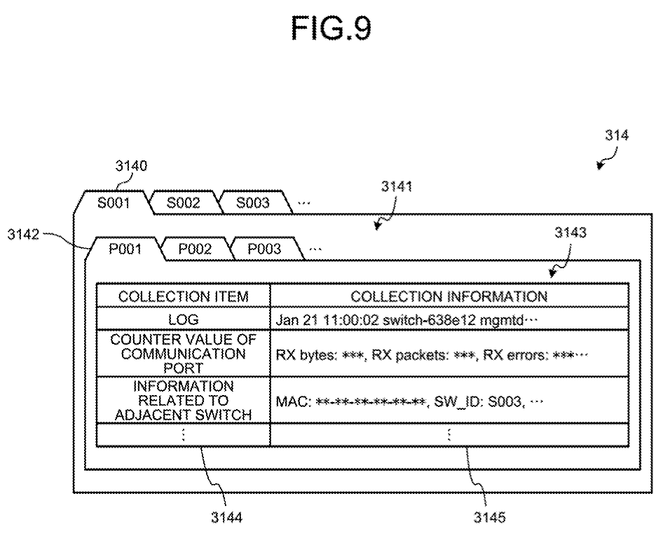

The storage unit 31 stores therein the per-port failure condition table 310, the per-port collection item table 311, the port information 312, the log 313, and a collection information table 314. FIG. 9 is a diagram illustrating an example of the collection information table 314. In the collection information table 314, a discrete table 3141 is stored for each of switch IDs 3140 that identify the corresponding switch devices 30. In each of the discrete tables 3141, a discrete table 3143 is stored for each of the port IDs 3142 that identify the corresponding communication ports 39. In each of the discrete tables 3143, collection information 3145 is stored in association with a collection item 3144.

If the collecting unit 35 receives the port ID of the communication port 39 from the determination unit 34 as a notification, the collecting unit 35 specifies, in the per-port collection item table 311, the discrete table that is associated with the notified port ID. Then, the collecting unit 35 collects, from the port information 312 or the log 313, the information associated with each of the items stored in the specified discrete table. Then, the collecting unit 35 refers to the collection information table 314 in the storage unit 31 and specifies the discrete table associated with the switch ID of the own device. Then, the collecting unit 35 refers to the specified discrete table and specifies the discrete table associated with the port ID received from the determination unit 34 as the notification. Then, the collecting unit 35 stores the information collected for each of the collection items in the specified discrete table.

Furthermore, the collecting unit 35 receives, together with the switch ID from the other switch device 30 corresponding to the unmanaged switch via the communication cable 20 connected to one of the communication ports 39, both the information collected for each collection item and the port ID of the communication port 39 in which the failure condition is satisfied. Then, the collecting unit 35 refers to a switching processing unit 3314 in the storage unit 31 and specifies the discrete table associated with the switch ID received from the unmanaged switch. Then, the collecting unit 35 refers to the specified discrete table and specifies the discrete table associated with the port ID received from the unmanaged switch. Then, the collecting unit 35 stores, in the specified discrete table, the information that is collected for each collection item and that is received from the unmanaged switch.

If the output unit 40 receives, from the management terminal 11 via the maintenance port 38, an instruction to output the collection information table 314, the output unit 40 acquires the collection information table 314 from the storage unit 31. Then, the output unit 40 outputs the data in the collection information table 314 to the management terminal 11 via the maintenance port 38. The management terminal 11 outputs the data in the collection information table 314 output from the management switch by displaying on a display. Consequently, if a communication failure occurs, the information processing system 10 can reduce the burden placed on the worker for collecting the information used to find out the portion in which the failure occurs or the cause of the failure.

Operation of the Switch Device 30

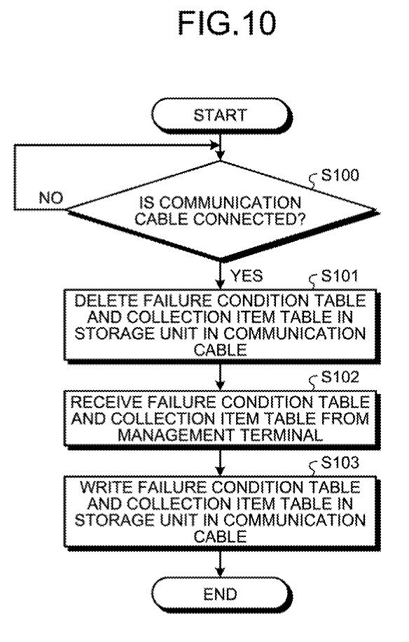

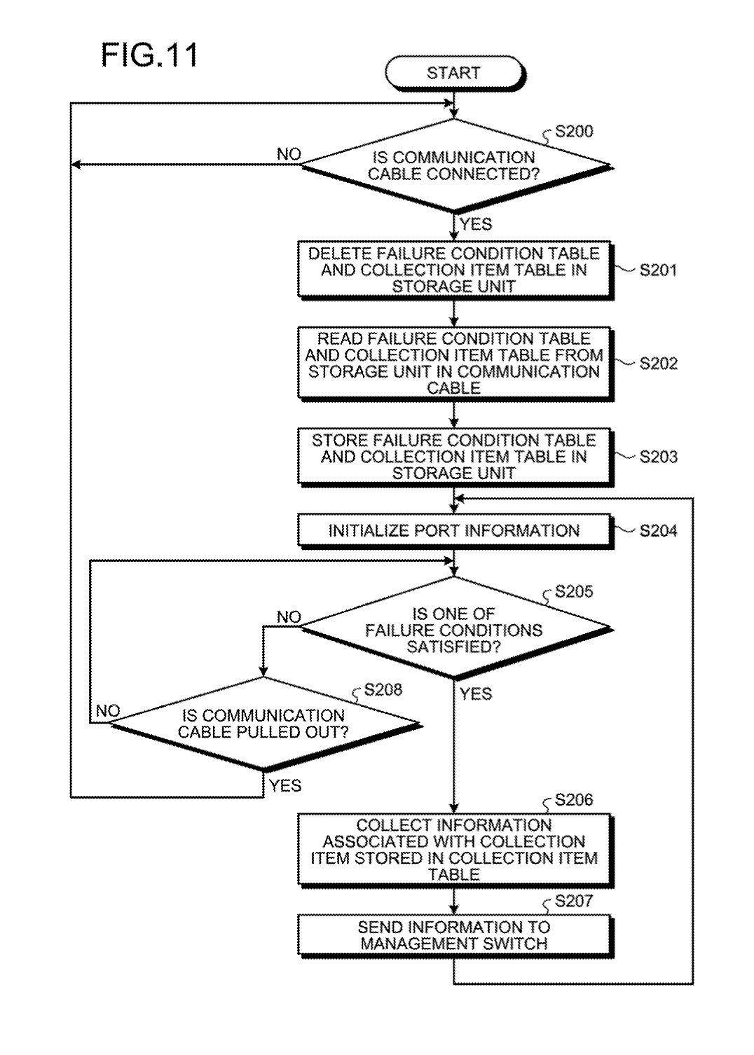

FIG. 10 and FIG. 11 are flowcharts each illustrating an example of an operation performed by the switch device 30. FIG. 10 illustrates an example of the operation of the switch device 30 when the failure condition table 220 and the collection item table 221 are written in the communication cable 20. For example, if the management terminal 11 is connected to the maintenance port 38 and the signal indicating the start of the writing is received from the management terminal 11, the switch device 30 starts the operation illustrated in FIG. 10.

First, the writing unit 37 determines which of the communication ports 39 is used to connect the communication cable 20 (Step S100). If the communication cable 20 is connected to one of the communication ports 39 (Yes at Step S100), the writing unit 37 accesses the storage unit 22 in the communication cable 20 and deletes the failure condition table 220 and the collection item table 221 in the storage unit 22 (Step S101).

Then, the writing unit 37 receives the data in the failure condition table 220 and the collection item table 221 from the management terminal 11 via the maintenance port 38 (Step S102). Then, the writing unit 37 writes the received data stored in the failure condition table 220 and the collection item table 221 in the storage unit 22 in the communication cable 20 (Step S103). Then, the switch device 30 ends the operation illustrated in the flowchart.

FIG. 11 illustrates an example of the operation of the switch device 30 running at the time of failure determination performed based on the failure condition table 220 and the collection item table 221 stored in the communication cable 20. Furthermore, the operation illustrated in FIG. 11 is performed on each of the communication ports 39 by the switch device 30.

First, the reading unit 32 monitors which of the communication ports 39 is used to connect the communication cable 20 (Step S200). If the communication cable 20 is connected to one of the communication ports 39 (Yes at Step S200), the reading unit 32 specifies, in the per-port failure condition table 310, the failure condition table 3101 associated with the port ID of the communication port 39 to which the communication cable 20 is connected. Then, the reading unit 32 deletes the data in the specified failure condition table 3101 (Step S201).

Furthermore, the reading unit 32 specifies, in the per-port collection item table 311 in the storage unit 31, the collection item table 3111 associated with the port ID of the communication port 39 to which the communication cable 20 is connected. Then, the reading unit 32 deletes the data in the specified collection item table 3111 (Step S201).

Then, the reading unit 32 reads, from the storage unit 22 in the communication cable 20 via the communication port 39, the data stored in the failure condition table 220 and the data stored in the collection item table 221 (Step S202). Then, the reading unit 32 stores, in the failure condition table 3101 specified at Step S201, the data stored in the failure condition table 220 read from the storage unit 22 in the communication cable 20 (Step S203). Furthermore, the reading unit 32 stores, in the collection item table 3111 specified at Step S201, the data stored in the collection item table 221 read from the storage unit 22 in the communication cable 20 (Step S203).

Then, the switching processing unit 33 initializes a communication cable 204 in the storage unit (Step S204). Then, the switching processing unit 33 starts the process of relaying the communication data via the communication port 39 to which the communication cable 20 is connected.

Then, the determination unit 34 refers to, regarding the communication port 39 to which the communication cable 20 is connected, the failure condition table 3101 and the port information 312 in the per-port failure condition table 310 for each predetermined timing. Then, the determination unit 34 determines which of the failure conditions included in the failure condition table 3101 is satisfied (Step S205).

If the determination unit 34 determines one of the failure conditions included in the failure condition table 3101 is satisfied (Yes at Step S205), the determination unit 34 notifies the collecting unit 35 of the port ID of the communication port 39 in which the failure condition is satisfied. The collecting unit 35 specifies, in the per-port collection item table 311, the collection item table 3111 associated with the port ID notified by the determination unit 34. Then, the collecting unit 35 collects, from the port information 312 or the log 313, the information associated with each of the collection items stored in the specified collection item table 3111 (Step S206).

Then, the collecting unit 35 sends the information collected for each of the collection items to the sending unit 36 together with the port ID of the communication port 39 in which the failure condition is satisfied. The sending unit 36 receives, from the collecting unit 35, both the information collected for each of the collection items and the port ID of the communication port 39 in which the failure condition is satisfied and then sends these pieces of the received information to, for example, the management switch together with the switch ID that identifies the own device (Step S207). Then, the switching processing unit 33 again performs the process indicated at Step S204.

In contrast, if the determination unit 34 determines none of the failure conditions included in the failure condition table 3101 is satisfied (No at Step S205), the reading unit 32 monitors whether the communication cable 20 is pulled out from the communication port 39 (Step S208). If the communication cable 20 is not pulled out from the communication port 39 (No at Step S208), the determination unit 34 again performs the process indicated at Step S205. In contrast, the communication cable 20 is pulled out from the communication port 39 (Yes at Step S208), the reading unit 32 again performs the process indicated at Step S200.

### Effect of the Embodiment

The embodiment has been described above. The information processing system 10 according to the embodiment includes the plurality of the switch devices 30 and the plurality of the communication cables 20 that connects between the switch devices 30. Each of the communication cables 20 has the storage unit 22 that stores therein the failure condition table 220 including the failure condition that is used for determination of failure occurrence and the collection item table including the item of the information collected when the failure condition is satisfied. Each of the switch devices 30 includes the communication port 39, the reading unit 32, the determination unit 34, the collecting unit 35, and the sending unit 36. The communication cable 20 is connected to the communication port 39. The reading unit 32 reads, if the communication cable 20 is connected to the communication port 39, both the failure condition table 220 and the collection item table 221 from the storage unit 22 provided in the communication cable 20. The determination unit 34 determines whether the state of the communication via the communication cable 20 connected to the communication port 39 satisfies the failure condition included in the failure condition table 220 that is read by the reading unit 32. If the determination unit 34 determines that the state of the communication via the communication cable 20 connected to the communication port 39 satisfies the failure condition, the collecting unit 35 collects the information corresponding to the collection item included in the collection item table 221 that is read by the reading unit 32. The sending unit 36 sends the information collected by the collecting unit 35 to the management switch. Consequently, the information processing system 10 can reduce the burden placed on the worker for the work of collecting the information from each of the switch devices 30 and the work of setting the information into each of the switch devices 30.

Furthermore, in the embodiment described above, the switch device 30 includes, for each of the communication ports 39, the storage unit 31 that stores therein the failure condition table 3101 and the collection item table 3111. Then, the reading unit 32 stores, in the failure condition table 3101 in the storage unit 31, the data in the failure condition table 220 read from the storage unit 22 provided in the communication cable 20 connected to the communication port 39. Furthermore, the reading unit 32 stores, in the collection item table 3111 in the storage unit 31, the data in the collection item table 221 read from the storage unit 22 provided in the communication cable 20 connected to the communication port 39. Furthermore, the determination unit 34 refers to the collection item table 3111 stored in the storage unit 31 and determines whether the state of communication via the communication port 39 satisfies the failure condition. Furthermore, the collecting unit 35 refers to the collection item table 3111 stored in the storage unit 31 and collects the information corresponding to the item included in the collection item table 3111. Consequently, the condition that is used for the determination of a failure and that is associated with the type of the communication cable 20 connected to the switch device 30 is automatically set in the switch device 30. Consequently, the information processing system 10 can reduce the burden placed on the worker for the work of setting information in each of the switch devices 30. Furthermore, if a failure occurs, pieces of information used to specify the cause of the failure are automatically collected from each of the switch devices 30 to the predetermined device. Consequently, if the failure occurs, the information processing system 10 can reduce the burden placed on the worker for the work of collecting the information used to find out the cause of the failure from each of the switch devices 30.

Furthermore, in the embodiment described above, the storage unit 22 stores therein the failure condition table 220 including the failure conditions that are in accordance with the type of the communication cables 20 provided with the storage unit 22. Consequently, if a test of the switch device 30 is performed by changing various types of the communication cables 20 to be connected to the switch device 30, it is possible to reduce the burden placed on the worker for setting the failure condition associated with the type of the communication cable 20 in the switch device 30.

Furthermore, in the embodiment described above, the switch device 30 includes the writing unit 37. The writing unit 37 writes the failure condition table 220 and the collection item table 221 received from the management terminal 11 in the storage unit 22 provided in the communication cable 20 connected to the communication port 39. Consequently, the worker who tests the switch device 30 can easily manufacture the communication cable 20 in which the failure condition table 220 and the collection item table 221 is stored in the storage unit 22.

Furthermore, in the embodiment described above, the sending unit 36 sends the information collected by the collecting unit 35 to the management switch from the communication port 39 that is different from the communication port 39 determined, by the determination unit 34, as the state of the communication satisfying the failure condition. Consequently, the sending unit 36 can more certainly deliver the information collected by the collecting unit 35 to the predetermined device, such as the management device, or the like.

Hardware

The components of each unit illustrated in the drawings described above are not always physically configured as illustrated in the drawings. In other words, the specific shape of a separate or integrated device is not limited to the drawings. Specifically, all or part of the device can be configured by functionally or physically separating or integrating any of the units depending on various kinds of loads or use conditions.

Furthermore, all or any part of the various processing functions held by the switch device 30 may also be executed by a central processing unit (CPU) (or a microcomputer, such as a micro processing unit (MPU), a micro controller unit (MCU), or the like). Furthermore, all or any part of the various processing functions may also, of course, be executed by programs analyzed and executed by the CPU (or the microcomputer, such as the MPU, the MCU, or the like) or executed by hardware by wired logic.

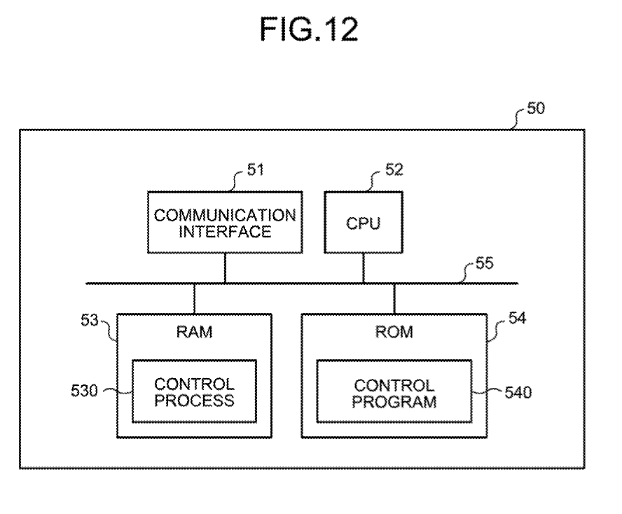

Various kinds of processes described in the above embodiments can be implemented by programs prepared in advance and executed by a communication device. Accordingly, in the following, a description will be given of an example of the communication device that executes programs having the same function as that described in the embodiment described above. FIG. 12 is a diagram illustrating an example of a communication device 50 that implements a function of the switch device 30.

As illustrated in FIG. 12, the communication device 50 includes a communication interface 51, a CPU 52, a random access memory (RAM) 53, and a read only memory (ROM) 54. The communication interface 51, the CPU 52, the RAM 53, and the ROM 54 are connected with each other via a bus 55.

The ROM 54 stores therein a control program 540 in advance. The CPU 52 reads the control program 540 from the ROM 54 and loads the control program 540 in the RAM 53. Similarly to the components illustrated in FIG. 5 or 6, the control program 540 may also be appropriately integrated or separated.

The CPU 52 reads the control program 540 from the ROM 54. Then, the CPU 52 loads the control program 540 in the RAM 53 as a control process 530. Then, the CPU 52 executes, in the embodiment described above, the control process 530 loaded in the RAM 53. For example, in the embodiment described above, if the switch device 30 functions as an unmanaged device, the CPU 52 executes the same functions as those performed by the reading unit 32, the switching processing unit 33, the determination unit 34, the collecting unit 35, the sending unit 36, and the writing unit 37. For example, in the embodiment described above, if the switch device 30 functions as the management device, the CPU 52 executes the same functions as those performed by the reading unit 32, the switching processing unit 33, the determination unit 34, the collecting unit 35, the writing unit 37, and the output unit 40. Furthermore, in the embodiment described above, by executing the control process 530 loaded in the RAM 53, the CPU 52 executes the processes illustrated in, for example, FIGS. 10 and 11.

Furthermore, regarding each of the processing units virtually implemented by the CPU 52, not all of the processing units are always implemented by the CPU 52 as long as only a processing unit used for a process is virtually implemented. Furthermore, the control program 540 does not need to be stored in the ROM 54 from the beginning. For example, each of the programs may also be stored in a portable recording medium, such as an IC card, inserted in the communication device 50 and the communication device 50 may also acquire each of the programs from the portable recording medium and execute the programs. Furthermore, the communication device 50 may also acquire and execute each of the programs from another computer, a server device, or the like that stores therein each of the programs via a wireless communication line, a public circuit, the Internet, a LAN, a WAN, or the like.

Others

In the embodiment described above, the per-port collection item table 311 stores therein, for each of the communication ports 39, the collection item table 3111; however, the disclosed technology is not limited to this. For example, if the item of the information collected when a failure occurs does not differ for each of the communication ports 39, the single collection item table 3111 that is common to the plurality of the communication ports 39 may also be stored in the storage unit 31.

Furthermore, all of the switch devices 30 do not need to have the writing unit 37 as long as, for example, at least the single switch device 30 included in the information processing system 10 includes the writing unit 37. Furthermore, the switch device 30 that includes the writing unit 37 does not need to have the functions of the storage unit 31, the reading unit 32, the switching processing unit 33, the determination unit 34, the collecting unit 35, the sending unit 36, and the output unit 40. In this case, the switch device 30 that includes the writing unit 37 may also function as a dedicated device that writes the data stored in the failure condition table 220 and the collection item table 221 into the storage unit 22 in the communication cable 20.

Furthermore, in the embodiment described above, if the determination unit 34 determines that one of the failure conditions included in the failure condition table 3101 is satisfied, the collecting unit 35 collects all of the pieces of information associated with the collection items included in the collection item table 3111. However, the disclosed technology is not limited to this. For example, a different collection item in the collection item table 3111 may also be associated with each of the failure conditions included in the failure condition table 3101. Then, if the determination unit 34 determines that one of the failure conditions included in the failure condition table 3101 is satisfied, the collecting unit 35 may also collect the information associated with the collection item associated with the subject failure condition from among the collection items included in the collection item table 3111. Consequently, it is possible to avoid the information that is not used to analyze a failure that has occurred from being collected. Consequently, it is possible to reduce the amount of data of the collected information and increase the working efficiency of finding out the cause of the failure.

According to an aspect of an embodiment of the present application, it is possible to reduce the burden placed on a worker for the work of collecting information from each of the information processing apparatuses and the work of setting the information in each of the information processing apparatuses.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus comprising:
a communication port to which a communication cable is connected;
a reading unit that reads, from a first storage unit provided in the communication cable when the communication cable is connected to the communication port, a failure condition table including a condition used for determination of failure occurrence and a collection item table including an item of information collected when the condition is satisfied;
a determination unit that determines whether a state of communication via the communication cable connected to the communication port satisfies the condition included in the failure condition table read by the reading unit;
a collecting unit that collects, when the determination unit determines that the state of the communication via the communication cable connected to the communication port satisfies the condition, the information corresponding to the item included in the collection item table read by the reading unit; and
a sending unit that sends the information collected by the collecting unit to a predetermined device.

2. The information processing apparatus according to claim 1, further comprising a second storage unit that stores therein, for each of the communication ports, the failure condition table and the collection item table, wherein
the reading unit stores, in the second storage unit, the failure condition table and the collection item table read from the first storage unit provided in the communication cable connected to the communication port,
the determination unit refers to the failure condition table stored in the second storage unit and determines whether the state of the communication via the communication port satisfies the condition, and
the collecting unit refers to the collection item table stored in the second storage unit and collects the information corresponding to the item included in the collection item table.

3. The information processing apparatus according to claim 1, wherein the first storage unit stores therein the failure condition table including the condition in accordance with the type of the communication cable provided with the first storage unit.

4. The information processing apparatus according to claim 1, further comprising a writing unit that writes, when the failure condition table and the collection item table are received from a management terminal that manages the failure condition table and the collection item table, in the first storage unit provided in the communication cable connected to the communication port, the failure condition table and the collection item table received from the management terminal.

5. The information processing apparatus according to claim 1, wherein the sending unit sends the information collected by the collecting unit from the communication port that is different from the communication port determined, by the determination unit, as the state of the communication satisfying the condition.

6. The information processing apparatus according to claim 1, wherein
a plurality of the conditions is included in the failure condition table, and
in the collection item table, the item of the information collected when the condition is satisfied is included for each of the conditions that are included in the failure condition table.

7. An information processing system comprising:
a plurality of information processing apparatuses; and
a plurality of communication cables that connects between the information processing apparatuses, wherein
each of the plurality of the communication cables includes a first storage unit that stores therein a failure condition table including a condition used for determination of failure occurrence and a collection item table including an item of information collected when the condition is satisfied,
each of the plurality of the information processing apparatuses includes
a communication port to which the communication cable is connected,
a reading unit that reads, from the first storage unit provided in the communication cable when the communication cable is connected to the communication port, the failure condition table and the collection item table,
a determination unit that determines whether a state of communication via the communication cable connected to the communication port satisfies the condition included in the failure condition table read by the reading unit,
a collecting unit that collects, when the determination unit determines that the state of the communication via the communication cable connected to the communication port satisfies the condition, the information corresponding to the item included in the collection item table read by the reading unit, and
a sending unit that sends the collection information collected by the collecting unit to a predetermined device.
